(19) United States
(12) Patent Application Publication
(10) Pub. No.: US 2024/0169349 A1
(43) Pub. Date: May 23, 2024

(54) Method for Attestation of a Hardware Wallet of a Blockchain

(71) Applicant: Infineon Technologies AG, Neubiberg (DE)

(72) Inventor: Alexander Köberl, Graz (AT)

(21) Appl. No.: 18/512,535

(22) Filed: Nov. 17, 2023

(30) Foreign Application Priority Data
Nov. 17, 2022 (DE) 102022130483.3

(51) Int. Cl. G06Q 20/40; G06Q 20/36; G06Q 20/38; G06Q 20/42

(52) U.S. Cl. CPC G06Q 20/401; G06Q 20/36; G06Q 20/3821; G06Q 20/3829; G06Q 20/389; G06Q 20/42

(57) ABSTRACT

According to various embodiments, a method for attestation of a hardware wallet of a blockchain is provided, comprising deploying a meta data service smart contract on the blockchain, wherein the meta data service smart contract is a smart contract storing information about certified hardware wallet models and deploying an attestation smart contract on the blockchain, wherein the attestation smart contract is a smart contract configured to receive attestation information of the hardware wallet, verify that the attestation information was sent from the hardware wallet and verify, by retrieving information from the meta data service smart contract, that the hardware wallet is of a certified hardware wallet model having required capabilities and provide an attestation confirmation for the hardware wallet if the attestation information was sent from the hardware wallet and the hardware wallet is of a certified hardware wallet model having the required capabilities.

### TECHNICAL FIELD

The present disclosure relates to methods for attestation of a hardware wallet of a blockchain.

### BACKGROUND

Secured key management is an important requirement for users of blockchain systems: by signing a transaction with their private key, users approve the transfer of funds and give explicit consent when interacting with smart contracts. The potentially high yield of stolen keys attracts many criminals to target users and crypto-exchanges with phishing and hacking attacks. Risk exposure to key fraud can be decreased by using hardware security modules or smart cards as so-called hardware wallets for secured key management. However, from the view of smart contracts and other users of the blockchain network, secured keys cannot be distinguished from unprotected ones. A system could be compromised if an unprotected key received a privileged role in a smart contract (e.g., administrator who is allowed to dispense funds) or a transaction was interpreted as explicit consent (e.g., to change the operating state of a cyber-physical systems).

Therefore, approaches are desirable for attestation of hardware wallets, in particular with regard to their protection capabilities.

### SUMMARY

According to various embodiments, a method for attestation of a hardware wallet of a blockchain is provided comprising deploying (i.e. deployment of) a meta data service smart contract on the blockchain, wherein the meta data service smart contract is a smart contract storing information about certified hardware wallet models, and deploying an attestation smart contract on the blockchain, wherein the attestation smart contract is a smart contract configured to receive attestation information of the hardware wallet, verify that the attestation information was sent from the hardware wallet, and verify, by retrieving information from the meta data service smart contract, that the hardware wallet is of a certified hardware wallet model having required capabilities and providing an attestation confirmation for the hardware wallet if the attestation information was sent from the hardware wallet and the hardware wallet is of a certified hardware wallet model having the required capabilities.

According to a further embodiment, a method for verification of a hardware wallet use is provided comprising a hardware wallet initiating execution of a function of a smart contract deployed on blockchain and configured to provide the function for hardware wallets having required capabilities, an attestation smart contract, which is a smart contract deployed on the blockchain configured to confirm that the hardware wallet has required capabilities, checking whether the hardware wallet is of a certified hardware wallet model having the required capabilities and, if the hardware wallet is of a certified hardware wallet model having the required capabilities, providing an attestation confirmation and the smart contract executing the function for the hardware wallet if the attestation smart contract provides the attestation confirmation.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a block diagram of a blockchain network, i.e. a computer network for managing and operating a blockchain.

FIG. 2 shows a flow diagram illustrating a blockchain-based attestation of a hardware wallet according to an embodiment.

FIG. 3 shows a flow diagram illustrating a blockchain-based attestation of a hardware wallet for the hardware wallet itself according to an embodiment.

FIG. 4 shows a flow diagram illustrating a method for attestation of a hardware wallet of a blockchain.

FIG. 5 shows a flow diagram illustrating a method for verification of a hardware wallet use.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

Blockchain technology is becoming more and more used for various applications. A blockchain can typically be seen as a distributed database that maintains a continuously-growing list of records secured against tampering. A blockchain typically includes a number of blocks of interaction records wherein each block includes a timestamp and a link to a previous block. For example, each block includes a hash of the preceding block. In other words, interaction records in a blockchain may be stored as a series of blocks that include a record of a number of transactions occurring over a given period of time. A new block may be appended to a blockchain by a blockchain provider after it completes the block and the block has been validated. A blockchain can for example be used to verify transactions. The security of a blockchain may be obtained using a cryptographic scheme.

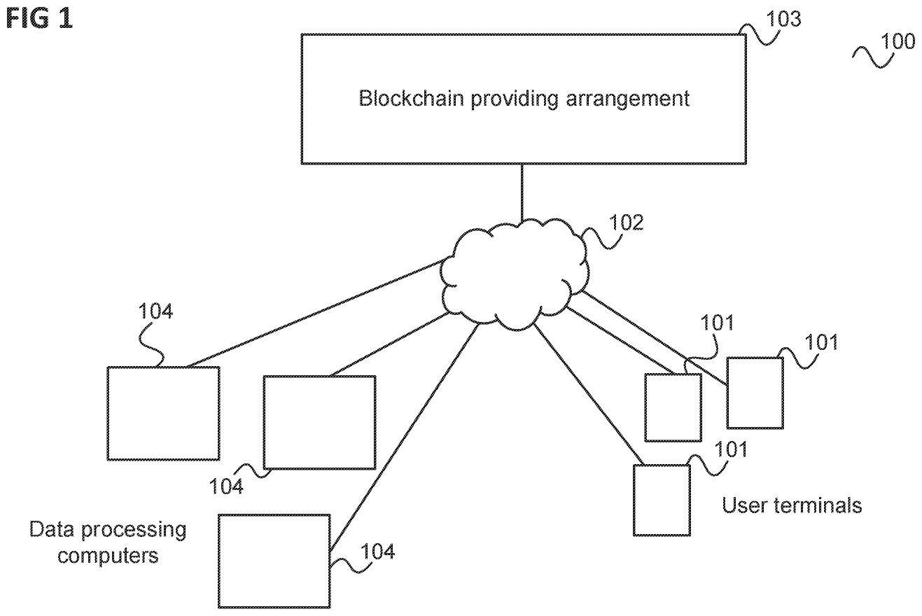

FIG. 1 shows a block diagram of a blockchain network 100, i.e. a computer network for managing and operating a blockchain.

The network 100 may include one or more user devices (or terminals) 101 and a blockchain provider computer arrangement 103 and one or more data processing computers 104. Each of these devices and computers may be communicatively coupled with each other via a communication network 102 such as the Internet using a suitable communication protocol.

A blockchain provider, e.g., the blockchain provider computer arrangement 103, can include one or more electronic devices configured to provide blockchain functionality. The blockchain provider computer arrangement 103 can include a single device or multiple devices configured to maintain aspects of the blockchain.

In the blockchain network 100, transaction request messages may be exchanged. A transaction request message may be understood as an electronic message utilized to request a transaction. A transaction may be initiated by a user device 101 (e.g., a user device operated by a user). A transaction may also be initiated by a data processing computer 104. The transaction request message for initiating a transaction may indicate a recipient of the transaction.

The transaction request message may, in case it relates to a transaction for example, include data fields including, but not limited to, an initiator identifier data field, a recipient identifier data field, a transfer value data field specifying the transaction value, a digital signature data field, a transaction value, a timestamp data field, and the like. In some examples, the transaction value may be in a format suitable for immediate recordation within a ledger managed by the blockchain provider computer arrangement 103. A transaction request message may be signed using a private key associated with the user or user device 101 initiating the transaction, such that it may be verified using a public key associated with the user or user device.

The blockchain provider computer arrangement 103 may include multiple blockchain provider computers wherein each one includes components for data processing such as a processor and a computer readable medium coupled to the processor, the computer readable medium including code, executable by the processor for performing the functionality described herein. The blockchain provider computer arrangement 103 may be communicatively coupled to the data processing computers 104 and to the user devices 101, e.g., via communication network 102. A computing device may act as blockchain provider computer 103 and as a user terminal 101 at the same time.

Depending on the blockchain that is used, the blockchain provider computer arrangement 103 may run smart contracts. A smart contract is a piece of software that can be deployed and be executed on a blockchain network 100. The characteristic of a smart contract is similar to software that runs on a classic web server (capable of process/store data) except it is decentralized. So, in case of the Ethereum blockchain, for example, a smart contract is a program that runs on the Ethereum blockchain. It is a collection of code (its functions) and data (its state) that resides at a specific address on the (e.g., Ethereum) blockchain.

Smart contracts can also be seen as a type of, for example, Ethereum account. This means they have a balance and can be the target of transactions. However they are not controlled by a user, instead they are deployed to the blockchain provider computer arrangement 103 and run as programmed. User devices 101 (using user accounts for the blockchain) can then interact with a smart contract by submitting transactions that execute a function defined on the smart contract. Smart contracts can define rules, like a regular contract, and automatically enforce them via the program code. Smart contracts cannot be deleted by default, and interactions with them are irreversible.

Distributed Ledger Technology (DLT) and the diverse set of blockchain implementations are used to manage large amounts of financial assets and host distributed Applications (dApps). Value transfer and calling functions in dApps are authorized through cryptographically signed transaction messages. In public blockchain networks, no additional user authentication is enforced. The private signing key becomes the central authentication factor, allowing anyone with the secret knowledge to authorize transactions from the account. From the user's perspective, such a Elliptic Curve Cryptography (ECC) key is impossible to memorize (in contrast to more common systems with password or PIN) and generating the signature is also a complex task. Therefore, a so-called wallet may be employed as or with a user device 101 to manage the keys and sign a given transaction. This can either be a web-based service (hot wallet), a software program executed on the user device 101 (software wallet) or a dedicated hardware module (hardware wallet), e.g., in the form of a smart card or USB stick, plugged into the user device 101. Both hot- and software wallets have a higher risk for exploits and unauthorized exporting of the private key than hardware wallets. Hardware wallets may provide a higher security level by utilizing hardened hardware and software, as well as advanced authentication mechanisms (e.g., finger print reader).

There are already commercial hardware wallets available, however, they do not offer attestation of the key provenance. In other words, given a public key, it cannot be proven that the corresponding private key is securely managed by a hardware wallet.

In view of the above, according to various embodiments, a blockchain-based attestation infrastructure is provided that allows certifying the provenance of keys in hardware wallets (i.e. attesting that key is managed by a hardware wallet) and attesting for a hardware wallet that it provides a required security mechanisms (e.g., required by a certain service provider). Verification of an attestation credential (also referred to as attestation information in the following) is done directly with smart contracts, thus removing the dependency on external verification services. According to one embodiment, the privacy of the user of the hardware wallet is protected by using Direct Anonymous Attestation (DAA).

The on-chain wallet attestation as provided by various embodiments may benefit blockchain users as follows:
1) Assurance for outgoing transactions, that the receiver of funds uses hardware security to protect the private key.
2) Strong non-repudiation evidence and enforcement of a minimum security level for functions provided by smart contracts. The signer of a transaction cannot easily deny explicit consent or blame key fraud when a hardware wallet is used.
3) Prove of device authenticity without relying on third party services.

According to various embodiments, a user of a user device 101 may for example request attestation information from the hardware wallet (plugged into the user device 101) for a specific blockchain key and forward it to an on-chain attestation service implemented as a smart contract for an attestation confirmation (e.g., confirming that the key is managed by a hardware wallet and the hardware wallet has certain security or protection capabilities such as a fingerprint scanner which has to be presented with a registered fingerprint before the blockchain key may be used). Functions of other smart contracts functions may subsequently to a successful attestation use the verification result (i.e. the attestation confirmation) and unlock functionality based on the security capabilities of the hardware wallet.

In particular, according to various embodiments, an extension of a generic hardware wallet protocol with attestation functions for an on-chain attestation using DAA with the Ethereum blockchain is provided.

Direct Anonymous Attestation (DAA) is a specialized group signature scheme for remote authentication. The Trusted Computing Group (TCG) considered multiple DAA schemes in the Trusted Platform Module (TPM) 2.0 specification. It has many implementation variants with complex cryptographic background.

In the simplest form, a credential is stored in the protected memory of a security module of a device (which may according to various embodiments be a hardware wallet) during manufacturing. The credential is, according to various embodiments, an example for attestation information. This credential can be seen as a token given by the manufacturer to the device, which can be used to authenticate with a third party. The credential contains a combined signature from the manufacturer's key (commonly called issuer) and a random secret key of the security module.

The credential is subsequently used to authenticate the device towards a third party. However, using the credential directly would reveal the identity of the user. For this reason, a randomized version of the credential is sent to the verifier. This randomized credential is used by the verifier to verify the signature and confirm that the data was indeed signed by a certified device. However, verifiers are not able to identify a particular device or link subsequent signatures if the credential was randomized again. This property even holds in case the issuer colludes with the verifier in exposing the identity of the device.

The advantages of the rather complex DAA scheme are best illustrated by comparing it to alternative approaches: a simple approach to prove group membership of a device (e.g., proving that a device is a specific model) is to place a common private key on all devices during manufacturing. Individual devices can then sign attestation messages to demonstrate knowledge of the secret key, without revealing their identity. This approach creates a high risk from the manufacturer's point of view: if an adversary is able to extract the private key from any of the deployed devices, or a concentrated brute-force attack succeeds, the attestation functionality of a complete device series is broken. DAA, in contrast, uses a unique secret key for each device and allows identification of all past and future pseudonyms by publishing the broken secret key to all verifiers. Another potential solution relies on a so-called privacy certification authority (privacy CA) as trusted third party. Every device creates a persistent key pair, which is known by the privacy CA. The device can use this key to authenticate and request a certificate for new pseudonyms in the future. However, this solution relies on the privacy CA for both availability and privacy. Devices are able to create a new pseudonym only when the privacy CA is available and it can potentially reveal the identity of the device by linking all previously used pseudonyms.

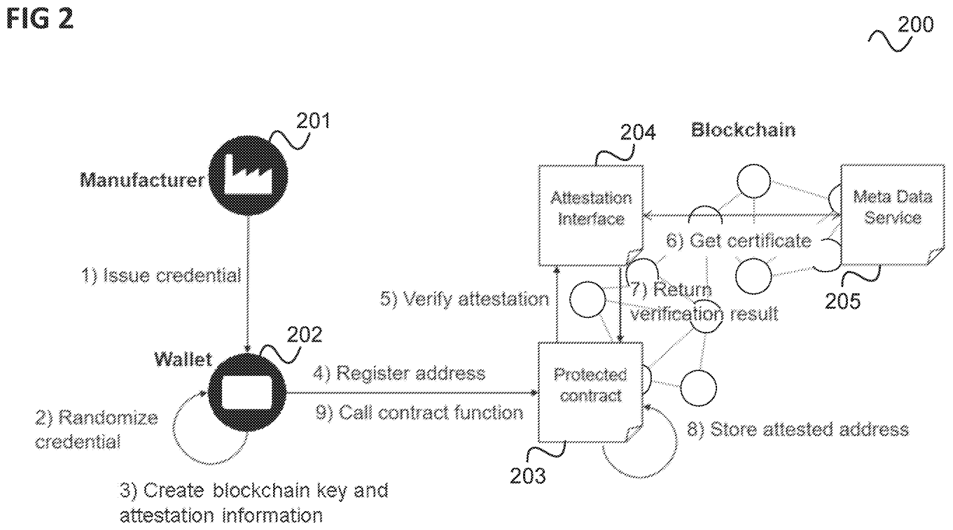

FIG. 2 shows a flow diagram 200 illustrating a blockchain-based attestation of a hardware wallet 202 according to an embodiment.

The hardware wallet 202 is a device with integrated Hardware Security Module (HSM) to manage blockchain keys and generate signatures for transactions. It may for example be plugged into one of the user devices 101. According to various embodiments, the hardware wallet 201 also generates attestation information to give information about the security capabilities it supports (such as a fingerprint scanner). The hardware wallet 201 stores cryptographic keys in a secured memory such that they cannot be exported.

An issuer 201 is responsible for generating an credential (e.g., cryptographic key or DAA credential) for a specific hardware wallet 202. This is typically the manufacturer of the hardware wallet 202 or at least the HSM.

Further, an attestation interface 204 is involved in the flow. This is a smart contract which provides functions to verify received attestation information (and therefore also referred to as attestation interface smart contract). It is either deployed on the blockchain as a standalone service or it is embedded into a smart contract with another main functionality.

The attestation happens with respect to (i.e. for) a protected smart contract 203: The protected smart contract 203 is a smart contract and can have a wide range of functionalities, e.g., multi signature wallet or token exchange. In addition to the specialized functions of the application domain, it provides a function to register new users by receiving their attestation information. It connects to the attestation interface 204 (either by calling another (e.g., dedicated smart contract) or by calling functionalities it includes itself) to verify the attestation information.

The attestation interface 204 consults a meta data service 205: the meta data service (MDS) 205 is a smart contract which stores information about every certified hardware wallet model (and therefore also referred to as meta data service smart contract). This information includes at least the manufacturer's public key and a list of capabilities (i.e. a specification of security measures available in hardware wallets of the hardware wallet model). It may also include more detailed certification data and a flag to mark vulnerable devices. A certified authority is responsible to update the stored data.

As illustrated in FIG. 2, the following operations are carried out for attestation of the hardware wallet 201 with respect to the protected smart contract 203:
1) The credential is written to the secured memory of the HSM of the hardware wallet 202. This can be a dedicated key for full basic attestation or a DAA credential as described above. This token allows the hardware wallet 202 to create attestation information to prove that it is of a specific hardware wallet model (e.g., that it is a certified device from a specific manufacturer).
2) In case of DAA, the hardware wallet 202 can randomize the token (credential) to prevent disclosure of the identity to the manufacturer and remove any link to previously signed attestation information.
3) On user request, the hardware wallet 202 creates a new blockchain key pair in its secured memory and derives a blockchain address corresponding to the blockchain key pair (e.g., derived from the public key of the blockchain key pair). It creates attestation information by signing the created blockchain address with the credential to prove the key provenance, i.e. certifying that the private key of the created key pair is securely stored in the hardware wallet 202 of the specific hardware wallet model.
4) When the user of the hardware wallet 202 wants to use the service provided by the protected smart contract 203, the user registers at the protected smart contract 203 by calling a provided function of the protected smart contract 203 by initiating a corresponding transaction which includes the attestation information in a specified format (as required by the protected smart contract 203). The hardware wallet 202 signs the transaction with the key created in 3).
5) The protected smart contract 203 uses the attestation interface (which may be functionality embedded in the protected smart contract 203 itself or another smart contract which the protected smart contract 203 calls) to verify the attestation data. This includes:
   5.1) Verification of the signature of the blockchain address (created in 3) by means of (public) information from the credential of the hardware wallet (either a public key or a DAA credential) which the hardware wallet includes in the attestation information. The hardware wallet for example appends its blockchain-address to other attestation data (like the public information from the credential of the hardware wallet), signs this and sends it with a blockchain transaction. The protected smart contract 203 may then read the address from the blockchain transaction.
   5.2) Comparison of the hardware wallet's blockchain address included in the signed attestation information with the actual sender of the transaction.
6) The attestation information includes some identifier which specifies the manufacturer and model of the wallet. The attestation interface 204 uses this information to read the manufacturer's public key and the capabilities of the hardware wallet model from the MDS 205.
7) With the public key of the manufacturer, the attestation 204 interface is able to confirm that the attestation data was indeed signed by a device of a certified hardware model by checking whether the credential includes a signature (or, depending on the specific protocol, other cryptographic data) from the manufacturer. The status of this verification (i.e. in particular an attestation confirmation if the verification that the hardware wallet is of a certified hardware model was successful) is returned to the protected smart contract 203.
8) If the verification has been successfully and the hardware wallet 202 satisfies the minimum security level the protected contract 203 requires (which it may determine from the model of the hardware model), the protected contract 203 stores the hardware wallet's blockchain address (included in the transaction) in association with the capabilities of the hardware wallet in a list.
9) The functions of the protected smart contract 203 can now be used by the hardware wallet 202 like any function of an ordinary smart contract. Before executing a restricted function, the protected smart contract 203 confirms that the blockchain address initiating execution of the restricted function was previously attested with the required security level by consulting the list.

The protected contract 203 may for example have a structure as follows

class MultiSignContract {
«require PIN»
function registerUser()
...
«require fingerprint»
function registerAdmin()
...
}

This means that the protected contract 203 registers a user as normal user only if the user's hardware wallet supports PIN protection of keys and registers a user as administrator only if the users' hardware wallet supports fingerprint protection of keys.

In the above example, the protected contract 203 requests attestation of the hardware wallet 202 from the attestation interface 203. Another use case is that the hardware wallet requests an attestation for itself (e.g., a user of the hardware wallet wants to verify that the hardware wallet is no fake device).

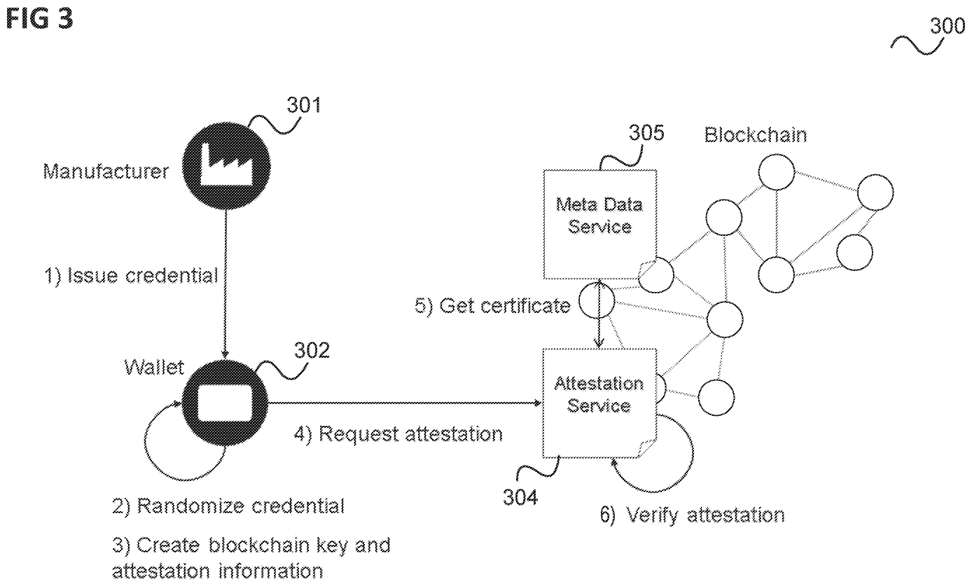

FIG. 3 shows a flow diagram 300 illustrating a blockchain-based attestation of a hardware wallet 302 for the hardware wallet 302 itself according to an embodiment.

Similarly to the flow diagram 200 of FIG. 3, an issuer 301, a hardware wallet 302, an attestation service 304 and a meta data service 305 are involved in the flow but the protected contract 203 is not involved.

Accordingly, operation 4) of FIG. 2 is replaced by a request for attestation to the attestation interface 304 (corresponding to 5) of FIG. 2). The following flow is as described with reference to FIG. 2), only that 8) and 9) are omitted and the attestation interface 304 sends the attestation confirmation in 6) back to the hardware wallet 302.

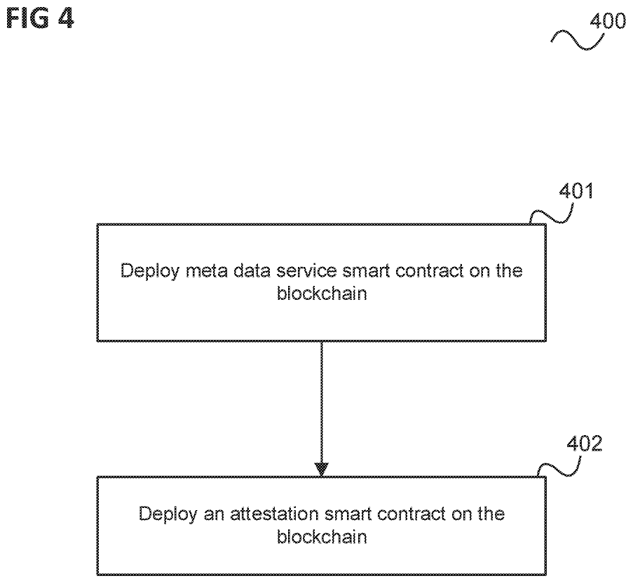

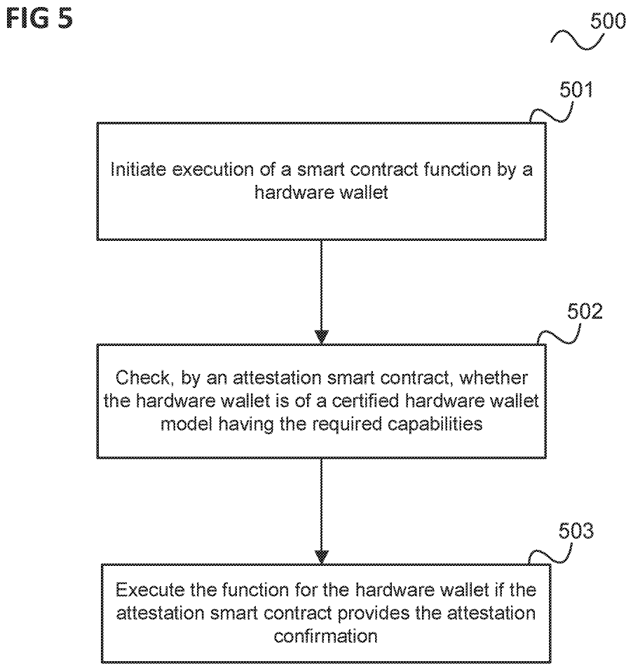

In summary, according to various embodiments, methods are provided as illustrated in FIG. 4 and FIG. 5.

FIG. 4 shows a flow diagram 400 illustrating a method for attestation of a hardware wallet of a blockchain.

In 401, a meta data service smart contract is deployed on the blockchain, wherein the meta data service smart contract is a smart contract storing information about certified hardware wallet models.

In 402, an attestation smart contract is deployed on the blockchain, wherein the attestation smart contract is a smart contract configured to receive attestation information of the hardware wallet, verify that the attestation information was sent from the hardware wallet and verify, by retrieving information from the meta data service smart contract, that the hardware wallet is of a certified hardware wallet model having required capabilities and provide an attestation confirmation for the hardware wallet if the attestation information was sent from the hardware wallet and the hardware wallet is of a certified hardware wallet model having the required capabilities.

It should be noted that the meta data service smart contract and the attestation smart contract may be implemented by a single smart contract combining the functionalities of both. In that case, the deployment of that single smart contract corresponds to the deployment of both the meta data service smart contract and the attestation smart contract. However, they may also be two separate smart contracts.

The method of FIG. 4 can be seen as the setup of the attestation functionality provided by the blockchain. The flow of FIG. 5 can be seen to be directed to its use.

FIG. 5 shows a flow diagram 500 illustrating a method for verification of a hardware wallet use.

In 501, a hardware wallet initiates execution of a function of a smart contract (referred to as “protected” smart contract in the examples above) deployed on blockchain and configured to provide the function for hardware wallets having required capabilities.

In 502, an attestation smart contract, which is a smart contract deployed on the blockchain configured to confirm that the hardware wallet has required capabilities, checks whether the hardware wallet is of a certified hardware wallet model having the required capabilities and, if the hardware wallet is of a certified hardware wallet model having the required capabilities, provides an attestation confirmation.

In 503, the third smart contract executes the function for the hardware wallet if the attestation smart contract provides the attestation confirmation.

As above, the (“protected”) smart contract and the attestation smart contract may be combined into one (i.e. the function of checking and of providing the attestation confirmation may be a function of the (“protected” smart contract). However, they may also be two separate smart contracts.

It should be noted that the checking whether the hardware wallet is of a certified hardware wallet model having the required capabilities may be performed before the initiating execution of a function of the smart contract, e.g., in response of a registration of the hardware wallet at the smart contract. In that case the smart contract may store, if the attestation smart contract provides the attestation confirmation, an indication that the hardware wallet has the required capabilities and execute the function for the hardware wallet (which the hardware wallet initiates at a later time) if it has stored an indication that the hardware wallet has the required capabilities. According to various embodiments, in other words an key provenance attestation scheme is implemented by one or more smart contracts deployed on a blockchain.

For example, a DAA scheme with on-chain verification of credentials is provided in which a hardware wallet creates attestation information for a blockchain address and a smart contract can verify attestation without a (off-chain) third party. The smart contract can thus enforce specific security level for every function it provides. For example, the use of an authenticator hardware for all members for multi-signature wallets and social recovery wallets may be enforced using this scheme and BYOD (bring your own device) may be supported for various applications. The scheme may in particular include a distributed meta data service provided on one or more smart contracts such that hardware capabilities and certificates may be read by the smart contract verifying the attestation from blockchain (rather than from an off-chain service).

According to various embodiments, the provided scheme may provide privacy-preserving access control, i.e. limit access to users with attested authenticators (e.g., an employee card). For example, it allows various applications with multi-credential storage, allows regulation of hardware wallets, e.g., enforce certified wallets with pseudonym revocation mechanisms for crypto exchanges/crypto services of banks and allows an authority to “freeze” assets or link pseudonym with identity in exceptional cases. For example, a hardware wallet type may be removed from the list of certified devices stored by the meta data service smart contract.

The methods may be carried out by one or more devices of a blockchain network as illustrated in FIG. 1. For example, a user terminal 101 may correspond to the hardware wallet and the various smart contracts may be deployed by one or more of the user terminals.

Various Examples are described in the following:

Example 1 is a method as described above with reference to FIG. 4.

Example 2 is the method of example 1, further comprising an issuer of the hardware wallet storing the information about the certified hardware wallet models in the meta data service smart contract.

Example 3 is the method of example 2, wherein the information about the certified hardware wallet models includes information about the capabilities of the certified hardware wallet models.

Example 4 is the method of example 2 or 3, wherein the issuer of the hardware wallet stores at least a part of the information about the certified hardware wallet models by calling a meta data function of the meta data service smart contract for updating information stored in the meta data service smart contract.

Example 5 is the method of any one of examples 2 to 4, wherein the information about the certified hardware wallet models includes a public key of the issuer.

Example 6 is the method of any one of examples 1 to 5, wherein the attestation smart contract is configured to verify, using the public key of the issuer, that the attestation information includes information of a credential provided by the issuer.

Example 7 is the method of example 6, wherein the information of the credential is a public key of a key pair or other cryptographic data provided by the issuer to the hardware wallet.

Example 8 is the method of example 6, wherein the credential corresponds to a public key of a Direct Anonymous Attestation credential provided by the issuer of the hardware wallet.

Example 9 is the method of any one of examples 1 to 8, wherein the attestation smart contract is a smart contract configured to receive the attestation information of the hardware wallet from a smart contract requesting attestation of the hardware wallet or from the hardware wallet requesting attestation for itself.

Example 10 is a method as described above with reference to FIG. 5.

Example 11 is the method of example 10, comprising the smart contract transmitting a request for a attestation confirmation to the attestation smart contract and the attestation smart contract, in response to the request, checking whether the hardware wallet is of a certified hardware wallet model having the required capabilities and, if the hardware wallet is of a certified hardware wallet model having the required capabilities providing an attestation confirmation to the smart contract, wherein the smart contract executes the function for the hardware wallet if it is provided by the attestation confirmation from the attestation smart contract.

Example 12 is the method of example 10 or 11, comprising the hardware wallet providing attestation information with a request for registration at the smart contract before initiating execution of the function, wherein the attestation smart contract checks whether the hardware wallet is of a certified hardware wallet model having the required capabilities using the attestation information.

Example 13 is the method of example 12, wherein the attestation smart contract checks whether the hardware wallet is of a certified hardware wallet model having the required capabilities using the attestation information in response to the registration.

Example 14 is the method of example 13, wherein the smart contract stores, if the attestation smart contract provides the attestation confirmation, an indication that the hardware wallet has the required capabilities and executes the function for the hardware wallet if it has stored an indication that the hardware wallet has the required capabilities.

Example 15 is a blockchain network configured to perform the method of any one of examples 1 to 14.

It should be noted that features of any one of the examples may be combined with any of the other examples. In particular, the attestation smart contract and the meta data service smart contract may, in context of the method for verification of a hardware wallet use carry out functions they comprise according to their deployment as described in context of the method for attestation of a hardware wallet of a blockchain.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for attestation of a hardware wallet of a blockchain, comprising:
deploying a meta data service smart contract on the blockchain, wherein the meta data service smart contract is a smart contract storing information about certified hardware wallet models; and
deploying an attestation smart contract on the blockchain, wherein the attestation smart contract is a smart contract configured to receive attestation information of the hardware wallet, verify that the attestation information was sent from the hardware wallet and verify, by retrieving information from the meta data service smart contract, that the hardware wallet is of a certified hardware wallet model having required capabilities and provide an attestation confirmation for the hardware wallet if the attestation information was sent from the hardware wallet and the hardware wallet is of a certified hardware wallet model having the required capabilities.

2. The method of claim 1, further comprising an issuer of the hardware wallet storing the information about the certified hardware wallet models in the meta data service smart contract.

3. The method of claim 2, wherein the information about the certified hardware wallet models includes information about the capabilities of the certified hardware wallet models.

4. The method of claim 2, wherein the issuer of the hardware wallet stores at least a part of the information about the certified hardware wallet models by calling a meta data function of the meta data service smart contract for updating information stored in the meta data service smart contract.

5. The method of claim 2, wherein the information about the certified hardware wallet models includes a public key of the issuer.

6. The method of claim 1, wherein the attestation smart contract is configured to verify, using the public key of the issuer, that the attestation information includes information of a credential provided by the issuer.

7. The method of claim 6, wherein the information of the credential is a public key of a key pair or other cryptographic data provided by the issuer to the hardware wallet.

8. The method of claim 6, wherein the credential corresponds to a public key of a Direct Anonymous Attestation credential provided by the issuer of the hardware wallet.

9. The method of claim 1, wherein the attestation smart contract is a smart contract configured to receive the attestation information of the hardware wallet from a smart contract requesting attestation of the hardware wallet or from the hardware wallet requesting attestation for itself.

10. A method for verification of a hardware wallet use, comprising:
a hardware wallet initiating execution of a function of a smart contract deployed on blockchain and configured to provide the function for hardware wallets having required capabilities;
an attestation smart contract, which is a smart contract deployed on the blockchain configured to confirm that the hardware wallet has required capabilities, checking whether the hardware wallet is of a certified hardware wallet model having the required capabilities and, if the hardware wallet is of a certified hardware wallet model having the required capabilities, providing an attestation confirmation; and
the smart contract executing the function for the hardware wallet if the attestation smart contract provides the attestation confirmation.

11. The method of claim 10, comprising the smart contract transmitting a request for a attestation confirmation to the attestation smart contract and the attestation smart contract, in response to the request, checking whether the hardware wallet is of a certified hardware wallet model having the required capabilities and, if the hardware wallet is of a certified hardware wallet model having the required capabilities providing an attestation confirmation to the smart contract, wherein the smart contract executes the function for the hardware wallet if it is provided by the attestation confirmation from the attestation smart contract.

12. The method of claim 10, comprising the hardware wallet providing attestation information with a request for registration at the smart contract before initiating execution of the function, wherein the attestation smart contract checks whether the hardware wallet is of a certified hardware wallet model having the required capabilities using the attestation information.

13. The method of claim 12, wherein the attestation smart contract checks whether the hardware wallet is of a certified hardware wallet model having the required capabilities using the attestation information in response to the registration.

14. The method of claim 13, wherein the smart contract stores, if the attestation smart contract provides the attestation confirmation, an indication that the hardware wallet has the required capabilities and executes the function for the hardware wallet if it has stored an indication that the hardware wallet has the required capabilities.

15. A blockchain network configured to perform the method of claim 10.
